(19) United States
(12) Patent Application Publication
(10) Pub. No.: US 2022/0236397 A1
(43) Pub. Date: Jul. 28, 2022

(54) POSITION ESTIMATION SYSTEM, INFORMATION PROCESSING DEVICE, NON-TRANSITORY COMPUTER-READABLE STORAGE MEDIUM, AND INFORMATION PROCESSING METHOD

(71) Applicant: Mitsubishi Electric Corporation, Tokyo (JP)

(72) Inventors: Jun YUKAWA, Tokyo (JP); Satoko MIKI, Tokyo (JP); Kensuke UEDA, Tokyo (JP)

(73) Assignee: Mitsubishi Electric Corporation, Tokyo (JP)

(21) Appl. No.: 17/615,587

(22) PCT Filed: Jun. 24, 2019
(86) PCT No.: PCT/JP2019/024894

§ 371 Date: Dec. 1, 2021

(51) Int. Cl. G01S 13/56; G01S 13/00; G01S 7/41

(52) U.S. Cl. CPC G01S 13/56; G01S 7/415; G01S 13/003

(57) ABSTRACT

The system includes: a controlling device (140); a transmitting device (110) to transmit a wireless signal; a receiving device (120) to detect a reception intensity of the wireless signal and to sequentially output reception intensity information indicating the detected reception intensity to the controlling device (140); and a person detecting device (130) to detect that a person exists in a predetermined range and to sequentially output predetermined person detection information to the controlling device (140), wherein the controlling device (140) specifies a signal pattern indicating a transition of the reception intensity during a predetermined period by using the reception intensity indicated by the reception intensity information input during the predetermined period, and estimates, to be the position where a person exists, the position of the person detecting device (130) in the specified signal pattern when the person detection information is input within the predetermined period.

### TECHNICAL FIELD

The present invention relates to a position estimation system, an information processing device, a program, and an information processing method.

### BACKGROUND ART

Conventionally, as a position estimation system that uses wireless communication, it is known that there has been a system that uses a wireless transmitting device and a wireless receiving device to estimate the position of a target.

For example, the position estimation system described in Patent Reference 1 receives a wireless communication signal transmitted from a wireless transmitting device with a wireless receiving device, calculates a reception intensity pattern or an occurrence probability of the reception intensity pattern of a direct wave from the wireless transmitting device and a reflected wave reflected by a target, and records the reception intensity pattern or the occurrence probability at a specific position in advance as a database. When performing a position estimation, this system refers to the database to estimate the position of the target from the position corresponding to the most similar reception intensity pattern or occurrence probability.

### PRIOR ART REFERENCE

### Patent Reference

Patent Reference 1: Japanese Patent No. 4868169 (pages 11 to 14 and FIG. 1)

### SUMMARY OF THE INVENTION

### Problem to be Solved by the Invention

The conventional position estimation system assumes a case where only one target is to be estimated. Therefore, for example, when there is a person other than the person to be the target of the position estimation, it is difficult to estimate the position.

Specifically, when two persons A and B are in one room and the position in the room of one of them is to be estimated, although the reflected wave from the person A becomes constant if the person A stays at the same position in the room, the intensity of the reflected wave from the person B varies depending on the position of the person B in the room. Therefore, the reception intensity pattern received by the wireless receiving device varies greatly depending on the position of the person B.

In order to estimate the position of the person A from the reception intensity pattern, in conventional position estimation system, it is necessary to register the reception intensity patterns or the occurrence probabilities for various cases for the person B being anywhere in the room in advance, which enlarges the database.

Furthermore, when there are two or more persons, or when a non-human target that reflects electromagnetic waves moves around, it is difficult to register various possible cases in the database, so that the conventional position estimation system cannot estimate the accurate position.

Accordingly, it is an object of one or more aspects of the present invention to estimate, even when there are multiple persons, the position of any one of them.

### Means of Solving the Problem

A position estimation system according to an aspect of the present invention includes: an information processing device; a transmitting device to transmit a wireless signal; a receiving device to detect a reception intensity of the wireless signal and to sequentially output reception intensity information indicating the detected reception intensity to the information processing device; and a person detecting device to sequentially output predetermined person detection information to the information processing device when a person existing within a predetermined range is detected, wherein the information processing device comprises: a reception intensity information input unit to receive input of the reception intensity information; a signal pattern information generating unit to generate signal pattern information indicating a signal pattern indicating a transition of the reception intensity in a predetermined period by using the reception intensity indicated by the reception intensity information input in the predetermined period; a person detection information input unit to receive input of the person detection information; and a position estimation unit to estimate, when the person detection information input unit receives input of the person detection information within the predetermined period the position of the person detecting device in the signal pattern indicated by the generated signal pattern information to be the position where a person exists.

An information processing device according to an aspect of the present invention includes: a reception intensity information input unit to receive, from a receiving device to detect a reception intensity of a wireless signal transmitted from a transmitting device and to sequentially output reception intensity information indicating the detected reception intensity, input of the reception intensity information; a signal pattern information generating unit to generate signal pattern information indicating a signal pattern indicating a transition of the reception intensity in a predetermined period by using the reception intensity indicated by the reception intensity information input in the predetermined period; a person detection information input unit to receive input of the person detection information from a person detecting device, the person detecting device detecting that a person exists within a predetermined range and sequentially outputting predetermined person detection information to the information processing device; and a position estimation unit to estimate, when the person detection information input unit receives input of the person detection information within the predetermined period, to be the position where a person exists, the position of the person detecting device in the signal pattern indicated by the generated signal pattern information.

A program according to an aspect of the present invention causes a computer to function as: a reception intensity information input unit to receive, from a receiving device to detect a reception intensity of a wireless signal transmitted from a transmitting device and to sequentially output reception intensity information indicating the detected reception intensity, input of the reception intensity information; a signal pattern information generating unit to generate signal pattern information indicating a signal pattern indicating a transition of the reception intensity in a predetermined period by using the reception intensity indicated by the reception intensity information input in the predetermined period; a person detection information input unit to receive input of the person detection information from a person detecting device, the person detecting device detecting that a person exists within a predetermined range and sequentially outputting predetermined person detection information to the information processing device; and a position estimation unit to estimate, when the person detection information input unit receives input of the person detection information within the predetermined period, to be the position where a person exists, the position of the person detecting device in the signal pattern indicated by the generated signal pattern information.

An information processing method according to an aspect of the present invention includes: receiving, from a receiving device to detect a reception intensity of a wireless signal transmitted from a transmitting device and to sequentially output reception intensity information indicating the detected reception intensity, input of the reception intensity information; generating signal pattern information indicating a signal pattern indicating a transition of the reception intensity in a predetermined period by using the reception intensity indicated by the reception intensity information input in the predetermined period; receiving input of the person detection information from a person detecting device, the person detecting device detecting that a person exists within a predetermined range and sequentially outputting predetermined person detection information to the information processing device; and estimating, when the person detection information input unit receives input of the person detection information within the predetermined period, to be the position where a person exists, the position of the person detecting device in the signal pattern indicated by the generated signal pattern information.

### Effects of the Invention

According to one or more aspects of the present invention, even when there are multiple persons, the position of any one of them can be estimated.

### BRIEF DESCRIPTION OF THE DRAWINGS

FIG. 1 is a block diagram schematically illustrating a configuration of a position estimation system according to an embodiment.

FIG. 2 is a block diagram schematically illustrating a configuration of a controlling device.

FIGS. 3A and 3B are block diagrams illustrating an example of a hardware configuration.

FIG. 4 is a flow chart illustrating an operation of the controlling device.

FIG. 5 is a schematic diagram illustrating a first example in which a plurality of persons exist in a room.

FIG. 6 is a schematic diagram illustrating a second example in which a plurality of persons exist in a room.

### MODE FOR CARRYING OUT THE INVENTION

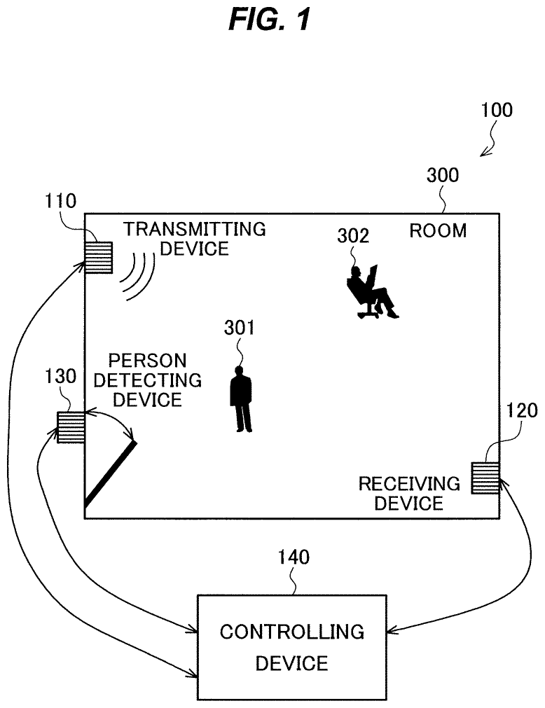

FIG. 1 is a block diagram schematically illustrating a configuration of a position estimation system 100 according to an embodiment.

The position estimation system 100 includes a transmitting device 110, a receiving device 120, a person detecting device 130, and a controlling device 140 as an information processing device.

The transmitting device 110, the receiving device 120, and the person detecting device 130 are connected to the controlling device 140.

The transmitting device 110, the receiving device 120, and the person detecting device 130 are arranged with respect to a room 300, so that the position of a detection target in the room 300 as the space for performing detection can be detected. Specifically, as shown in FIG. 1, the transmitting device 110 and the receiving device 120 are disposed within the room 300, the person detecting device 130 is disposed at the entrance of the room 300, and the controlling device 140 is disposed outside the room 300.

The arrangement of these devices is not limited to the example shown in FIG. 1, and for example, at least one of the transmitting device 110 and the receiving device 120 may be disposed outside the room 300, or the person detecting device 130 may be disposed in the room 300. The controlling device 140 may also be disposed in the room 300.

Further, a plurality of transmitting devices 110, a plurality of receiving devices 120, or a plurality of person detecting devices 130 may be provided.

It is assumed that there are a person 301 and a person 302 as targets of position detection in the room 300, but the target of detection is not limited to a person but may be an object, which is not a person, or the objects to be detected are not limited to two targets as long as they are one or more targets.

The transmitting device 110 transmits a wireless signal.

The receiving device 120 receives the wireless signal transmitted from the transmitting device 110. The receiving device 120 detects reception intensity of the received wireless signal and sequentially outputs reception intensity information indicating the detected reception intensity to the controlling device 140. Alternatively, the controlling device 140 may convert the reception intensity of the wireless signal detected by the receiving device 120 into reception intensity information.

Although not shown, in a case where a plurality of transmitting devices 110 are provided in the room 300 and wireless signals transmitted from each of the plurality of transmitting devices 110 can be distinguished by frequency, the receiving device 120 provides reception intensity information indicating the reception intensity for each frequency to the controlling device 140.

The wireless communication between the transmitting device 110 and the receiving device 120 may be, for example, wireless LAN (Local Area Network) communication called Wi-Fi® or peer-to-peer wireless communication called Bluetooth®.

By using wireless communication such as Wi-Fi or Bluetooth, the transmitting device 110 and the receiving device 120 can be implemented at a low cost without the need for dedicated wireless communication components. Further, the position estimation system 100 can be implemented by using a general device without preparing a device dedicated to position estimation.

In the position estimation by the position estimation system 100, in addition to the purpose of position estimation, a wireless signal transmitted from the transmitting device 110 may be used for the purpose of transmitting necessary information or a program, or a wireless signal transmitted from the transmitting device 110 may be used exclusively for position estimation during a period when communication is not used for the purpose of transmitting necessary information or a program. In a case of using a wireless signal dedicated to position estimation, a wireless signal suitable for position estimation can be utilized, so that the position estimation processing is simplified.

The person detecting device 130 detects that a person exists near the person detecting device 130. For example, the person detecting device 130 detects that a person exists within a predetermined range. Upon detecting that a person exists in proximity, the person detecting device 130 outputs person detection information indicating the detection to the controlling device 140. The person detection information may be produced in a predetermined format.

The person detecting device 130 can be provided with, for example, a human proximity sensor that detects the proximity of a human in a non-contact manner or an image recognition sensor having a camera that captures an image and analyzing the camera image to detect the presence of a human in a specific region.

The person detecting device 130 can also be implemented by a wireless signal intensity sensor that detects the intensity of a wireless signal emitted from a mobile terminal such as a smartphone or tablet held by a person and determines that the person is close when a signal intensity equal to or greater than a predetermined value is detected.

Although these sensors can detect the proximity of a person with high probability, they are generally expensive.

The person detecting device 130 can also be implemented by a door opening/closing switch that detects the opening or closing state of a door of the room by a physical switch or a non-contact switch to determine that the person who opens or closes the door is at a close position. The person detecting device 130 may be implemented as an operation detecting device such as a household electric appliance or the like which is installed at a specific position and detects an operation by a person to detect that the person is at a close position. The person detecting device 130 can also be implemented as a sound generation source specifying device for specifying the position where a sound is generated by sensing the sound generated when a person walks or acts.

These devices can be implemented at a relatively low cost because they can be implemented by using simple on-off physical switches, buttons for operation in other devices, microphones, or the like. However, since these devices detect the proximity of a person only when a person conducts an operation or generates a sound, they cannot detect the proximity of a person when there is no human operation or sound generation.

The controlling device 140 detects the position of one of the persons 301, 302 in the room 300 on the basis of the reception intensity information from the receiving device 120 and the person detection information from the person detecting device 130.

Here, although the controlling device 140 can be connected with the transmitting device 110, the receiving device 120, and the person detecting device 130 by wired connection, it can also be wirelessly connected with them if the wireless signal for position estimation is not affected.

Further, the controlling device 140 does not necessarily have to control the transmitting device 110, the receiving device 120, and the person detecting device 130. However, in order to analyze the signal of the wireless communication with high accuracy, it is desirable that the controlling device 140 can control the transmission timing of the wireless signal from the transmitting device 110, the reception sensitivity of the receiving device 120, and the detection ability of the person detecting device 130, among others.

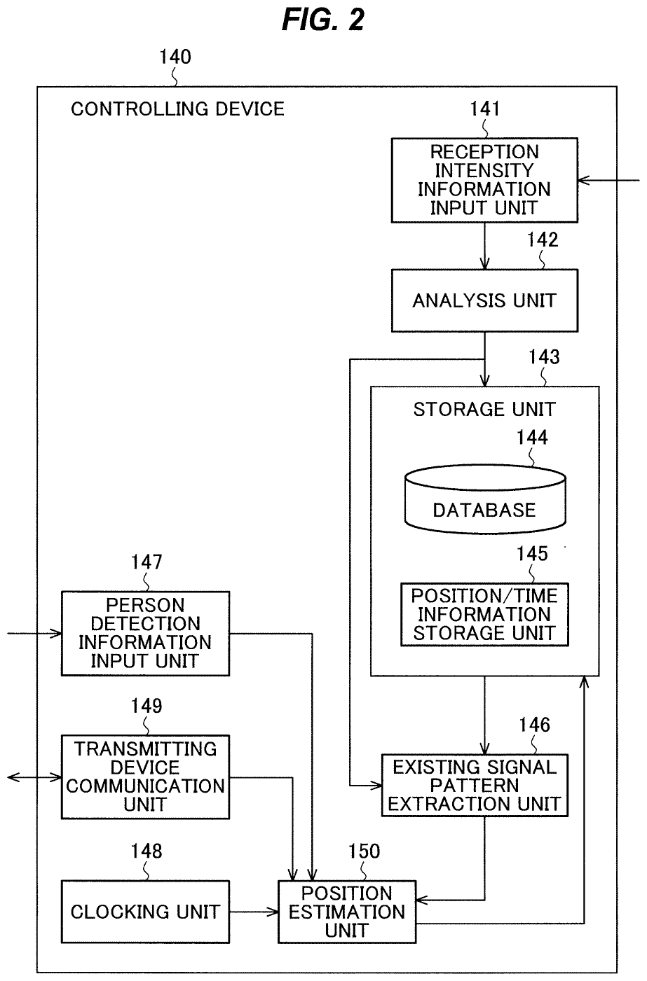

FIG. 2 is a block diagram schematically illustrating a configuration of the controlling device 140.

The controlling device 140 includes a reception intensity information input unit 141, an analysis unit 142, a storage unit 143, an existing signal pattern extraction unit 146, a person detection information input unit 147, a clocking unit 148, a transmitting device communication unit 149, and a position estimation unit 150.

The reception intensity information input unit 141 receives input of reception intensity information by the receiving device 120. The input reception intensity information is supplied to the analysis unit 142.

The analysis unit 142 functions as a signal pattern information generating unit that analyzes the wireless signal received by the receiving device 120 to generate signal pattern information.

For example, the analysis unit 142 uses the reception intensity indicated by the reception intensity information input to the reception intensity information input unit 141 in a predetermined period to generate signal pattern information indicating a signal pattern indicating the transition of the reception intensity in the predetermined period. The generated signal pattern information is stored as the existing signal pattern information in a database 144 to be described later in the storage unit 143. The signal pattern information is supplied to the existing signal pattern extraction unit 146.

The storage unit 143 stores information necessary for processing in the controlling device 140.

For example, the storage unit 143 includes a database 144 and a position/time information storage unit 145.

The database 144 is an existing signal pattern related information storage unit that associates existing signal pattern information with its related information and stores the associated information.

For example, the database 144 defines signal pattern information in the past as existing signal pattern information, associates the existing signal pattern information with related information generated when the existing signal pattern information was generated, and stores the associated information. The related information, which will be described later, includes estimated position information, elapsed time information, and person detecting device attribute information.

The position/time information storage unit 145 stores position/time information indicating a position and a time point at which a person is detected by the person detecting device 130. Although not shown, in a case where the position estimation system 100 includes a plurality of person detecting devices 130, the position/time information includes device identification information of the person detecting device 130 that transmitted the person detection information.

The existing signal pattern extraction unit 146 is a reading unit that reads out, from the database 144, related information associated with one piece of the existing signal pattern information indicating a signal pattern most similar to the signal pattern indicated by the signal pattern information supplied from the analysis unit 142, as existing signal pattern related information.

Since the signal pattern information supplied from the analysis unit 142 is already stored in the database 144 as the existing signal pattern information, the existing signal pattern extraction unit 146 extracts, from the database 144, the most similar signal pattern except the signal pattern indicated by the same signal pattern information supplied from the analysis unit 142.

Here, in a case where the database 144 stores a plurality of pieces of existing signal pattern information similar to the signal pattern indicated by the signal pattern information supplied from the analysis unit 142, the existing signal pattern extraction unit 146 reads out, from the plurality of pieces of existing signal pattern information, related information associated with one piece of the existing signal pattern information in which the position indicated by the associated person detecting device attribute information is the same as the position of the person detecting device 130 that last input the person detection information to the person detection information input unit 147.

Alternatively, in a case where the database 144 stores a plurality of pieces of the existing signal pattern information similar to the signal pattern indicated by the signal pattern information supplied from the analysis unit 142, the existing signal pattern extraction unit 146 reads out, from the plurality of pieces of existing signal pattern information, related information associated with one piece of the existing signal pattern information in which the position indicated by the associated person detecting device attribute information is the same as the position of the person detecting device 130 that last input the person detection information to the person detection information input unit 147 and the elapsed time indicated by the associated elapsed time information is the shortest.

The person detection information input unit 147 receives input of the person detection information from the person detecting device 130.

The person detection information is supplied to the position estimation unit 150.

The clocking unit 148 measures time. Here, the time measured by the clocking unit 148 is assumed to be the current time. The clocking unit 148 supplies time information indicating the current time to the position estimation unit 150.

When the person detection information is supplied from the person detection information input unit 147, the position estimation unit 150 obtains the current time from the clocking unit 148, generates position/time information indicating the position of the person detecting device 130 that transmitted the person detection information and the obtained time point, and stores the position/time information in the position/time information storage unit 145 of the storage unit 143.

Here, it is assumed that the position estimation unit 150 already knows the position where the person detecting device 130 is disposed. For example, although not shown, it is assumed that position information indicating the position of the person detecting device 130 is stored in the storage unit 143.

If there is only one person detecting device 130 in the room 300, which is the space for performing detection, the person detecting device 130 may transmit person detection information indicating that a person has been detected.

On the contrary, in a case where a plurality of person detecting devices 130 are arranged in the room 300, each of them may include device identification information to identify each device in the person detection information. The position estimation unit 150 specifies the position of the person detecting device 130 that transmitted the person detection information on the basis of the device identification information.

It should be noted that the person detection information may include information indicating the position of the person detecting device 130 that detected a person.

The transmitting device communication unit 149 communicates with the transmitting device 110. For example, in a case where the controlling device 140 controls the timing or the like of a wireless signal to be transmitted from the transmitting device 110 when position detection is performed, the position estimation unit 150 controls the transmitting device 110 via the transmitting device communication unit 149.

The transmitting device communication unit 149 may also receive input of transmitting device information, which is information about the transmitting device 110.

In order to estimate the position of any person 301, 302 in the room 300, the position estimation unit 150 uses at least any one piece of existing signal pattern related information supplied from the existing signal pattern extraction unit 146, person detection information supplied from the person detection information input unit 147, position/time information stored in the position/time information storage unit 145, and time information from the clocking unit 148.

For example, in a case where the person detection information input unit 147 receives input of the person detection information within a predetermined period during which the signal pattern is specified, the position estimation unit 150 estimates, to be the position where a person exists, the position of the person detecting device 130 that output the person detection information in the signal pattern.

In a case where the person detection information input unit 147 has received no input of the person detection information within a predetermined period during which the signal pattern is specified, when the position indicated by the person detecting device attribute information read by the existing signal pattern extraction unit 146 is the same as the position of the person detecting device 130 that last input the person detection information to the person detection information input unit 147, and the elapsed time indicated by the elapsed time information read by the existing signal pattern extraction unit 146 is shorter than the predetermined time, the position estimation unit 150 estimates, to be the position where a person exists, the position of the person detecting device 130 that last input the person detection information to the person detection information input unit 147.

Furthermore, in a case where the person detection information input unit 147 receives no input of the person detection information within a predetermined period during which the signal pattern is specified, when the position indicated by the person detecting device attribute information read by the existing signal pattern extraction unit 146 is the same as the position of the person detecting device 130 that last input the person detection information to the person detection information input unit 147, and the elapsed time indicated by the elapsed time information read by the existing signal pattern extraction unit 146 is equal to or longer than the predetermined time, the position estimation unit 150 estimates, to be the position where a person exists, a corrected position calculated by correcting the position of the person detecting device 130 in which the person detection information was last input to the person detection information input unit 147 by a distance through which a person moves in the elapsed time since the person detection information was last input to the person detection information input unit 147.

Then, the position estimation unit 150 stores estimated position information indicating the estimated position, elapsed time information indicating the elapsed time since the person detection information was last input to the person detection information input unit 147, and person detecting device attribute information indicating the position of the person detecting device 130 that last input the person detection information to the person detection information input unit 147 in the database 144 as related information in association with corresponding existing signal pattern information stored in the database 144. Although not shown, in a case where the position estimation system 100 includes a plurality of person detecting devices 130, the person detecting device attribute information includes device identification information of the person detecting device 130 that transmitted the person detection information used for position estimation.

The position estimation unit 150 may output the estimated position information indicating the position estimated as described above to an external device via an output unit not shown.

For example, the estimated position information can be used as input information for another process such as action prediction.

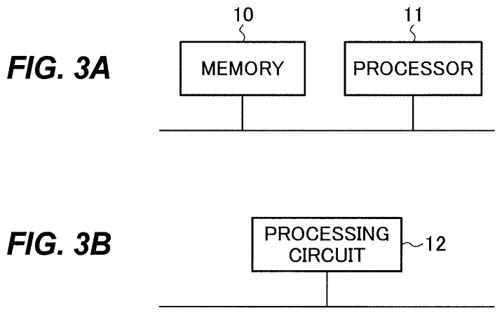

As shown in FIG. 3A, for example, some or all of the analysis unit 142, the existing signal pattern extraction unit 146, the clocking unit 148, and the position estimation unit 150 described above can be implemented by a memory 10 and a processor 11 such as a CPU (Central Processing Unit) for executing a program stored in the memory 10. Such a program may be provided through a network or recorded on a recording medium. That is, such a program may be provided, for example, as a program product.

Alternatively, as shown in FIG. 3B, some or all of the analysis unit 142, the existing signal pattern extraction unit 146, the clocking unit 148, and the position estimation unit 150 may be implemented by a processing circuit 12 such as a single circuit, a composite circuit, a programmed processor, a parallel programmed processor, an ASIC (Application Specific Integrated Circuit), or an FPGA (Field Programmable Gate Array).

The storage unit 143 may be implemented by a recording device such as an HDD (Hard Disk Drive) or SSD (Solid State Drive).

The reception intensity information input unit 141, the person detection information input unit 147, and the transmitting device communication unit 149 may be implemented by a communication device such as an NIC (Network Interface Card).

Next, the processing of the controlling device 140 to receive the reception intensity signal and the person detection information, and to estimate the position will be described.

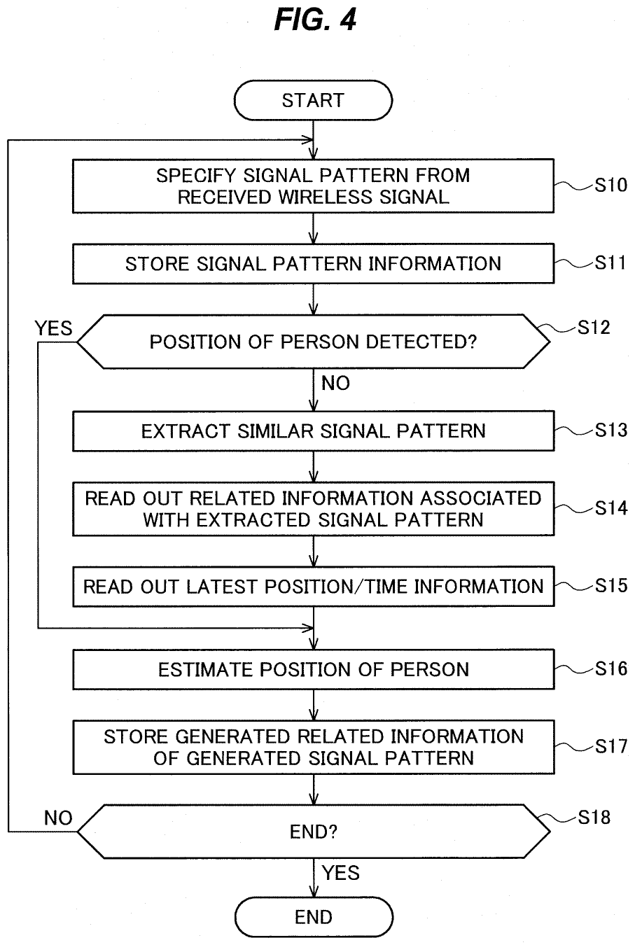

FIG. 4 is a flowchart illustrating an operation of the controlling device 140.

First, the analysis unit 142 uses the reception intensity indicated by the reception intensity information input to the reception intensity information input unit 141 to specify a signal pattern and generates signal pattern information indicating the specified signal pattern (S10).

For example, in a case where the position estimation system 100 includes one transmitting device 110, part of the wireless signal transmitted from the transmitting device 110 is received by the receiving device 120 as a direct wave without circumventing by reflection or the like. Further, another part of the transmitted wireless signal collides an object having an influence on the path of the electromagnetic wave, such as the person 301, and is received by the receiving device 120 as a reflected wave. In this case, since a difference occurs in the length of the path traveled by the wireless signal, which is an electromagnetic wave, the receiving device 120 receives the same wireless signal as a plurality of signals having a time difference. The electromagnetic waves arriving as reflected waves are generated under the influence of various objects in the room 300, and the path lengths to the receiving device 120 are different from each other. Therefore, the two-dimensional information of the time in a short time and the reception intensity of the wireless signal received by the receiving device 120 is information reflecting the distribution of objects having an influence on the electromagnetic waves, including the persons 301, 302 in the room 300. This is called the signal pattern of the received wireless signal.

Also, although not shown, in a case where the position estimation system 100 includes a plurality of transmitting devices 110, each transmitting device 110 characterizes and transmits a wireless signal for each transmitting device 110. In such a case, the signal pattern of the wireless signal received by the receiving device 120 has a more complicated configuration. Specifically, when different frequencies are assigned to each of the plurality of transmitting devices 110, the signal pattern is identified as three-dimensional information of frequency, time, and signal intensity.

Also, although not shown, in a case where the position estimation system 100 includes a plurality of receiving devices 120, each of the plurality of receiving devices 120 has a different linear distance from the transmitting device 110, and also has a different path length through which a reflected wave from an object affecting an electromagnetic wave travels. Therefore, in such a case, the signal pattern is specified as three-dimensional information of the type of the receiving device 120, time, and signal intensity. In such a case, the receiving device 120 includes the type of its own device in the reception intensity information.

Although not shown, in a case where the position estimation system 100 includes a plurality of transmitting devices 110 and a plurality of receiving devices 120, a different frequency is assigned to each of the plurality of transmitting devices 110 in the same manner as described above. In such a case, the signal pattern is specified as four-dimensional information of the type of the receiving device 120, frequency, time, and reception intensity.

Next, the analysis unit 142 arranges the specified signal pattern into a storable form to generate signal pattern information indicating the specified signal pattern, and stores the generated signal pattern in the database 144 (S11).

It should be noted that, in order to store the related information in an associated manner in the subsequent step, a unique number is assigned to each pieces of the signal pattern information stored in step S11.

In addition, the analysis unit 142 supplies the signal pattern information generated in step S10 together with the unique number to the existing signal pattern extraction unit 146.

Next, in step S10, the position estimation unit 150 determines whether or not the person detection information is input to the person detection information input unit 147 after the input of the reception intensity information from the receiving device 120 is started (S12). If the person detection information is input (Yes in S12), the process proceeds to step S16, and if the person detection information is not input (No in S12), the process proceeds to step S13.

In step S13, the existing signal pattern extraction unit 146 extracts a signal pattern most similar to the signal pattern indicated by the signal pattern information supplied from the analysis unit 142 in this time from the signal patterns indicated by the existing signal pattern information which is the past signal pattern information stored in the database 144. In this case, extraction in this time is performed from the signal patterns indicated by the existing signal pattern information having a unique number other than the unique number supplied from the analysis unit 142.

Here, since the signal pattern is constituted as a set of multidimensional number of states as described above, as a method for extracting the most similar signal pattern, there is a method for extracting the signal pattern having the shortest distance between two signal patterns. Distance functions capable of calculating a mathematical distance space, such as the Euclidean distance, the Mahalanobis distance, the Chebyshev distance, or the Minkowski distance, are used as preferable methods for calculating the distance between pieces of multi-dimensional information.

Next, the existing signal pattern extraction unit 146 reads out the related information stored in association with the signal pattern information indicating the extracted signal pattern (S14). The related information includes estimated position information, elapsed time information, and person detecting device attribute information.

Next, the position estimation unit 150 reads out the latest position/time information from the position/time information storage unit 145 (S15). The latest position/time information is information indicating the position of the person detection information input unit 147 that transmitted the last person detection information and the time point at which the last person detection information was transmitted. Then, the process proceeds to step S16.

In step 16, the position estimation unit 150 uses at least any one piece of existing signal pattern related information supplied from the existing signal pattern extraction unit 146, person detection information supplied from the person detection information input unit 147, position/time information stored in the position/time information storage unit 145, and time information from the clocking unit 148 to estimate the position of any one of the persons 301, 302 in the room 300.

Specifically, in a case where the person detection information is input in step S12 (Yes in step S12), the position estimation unit 150 estimates, to be the position where any one of the persons 301, 302 exists, the position of the person detecting device 130 that transmitted the person detection information.

When the person detection information is input, performing such estimation eliminates the necessity of the processing for searching the database 144 by the existing signal pattern extraction unit 146, thereby reducing the load of the processing for position estimation. Further, the position of any one of the persons 301, 302 can be estimated with higher accuracy than the position estimated by comparing the signal patterns of the wireless signals.

On the contrary, in a case where the person detection information is not input in step S12 (No in S12), the position estimation unit 150 estimates the position of the person 301 or 302 by using the existing signal pattern related information supplied from the existing signal pattern extraction unit 146, the latest position/time information stored in the position/time information storage unit 145, and the time information from the clocking unit 148.

Specifically, when the position indicated by the person detecting device attribute information included in the existing signal pattern related information coincides with the position indicated by the latest position/time information, the position estimation unit 150 estimates the position of the person 301 or 302 from the position indicated by the latest position/time information.

For example, when the elapsed time indicated by the elapsed time information included in the existing signal pattern related information is shorter than a predetermined time, the position estimation unit 150 estimates the position of the person 301 or 302 as the position indicated by the latest position/time information.

On the contrary, when the elapsed time indicated by the elapsed time information included in the existing signal pattern related information is equal to or longer than a predetermined time, the position estimation unit 150 corrects the position indicated by the latest position/time information, because there is a high possibility that the person 301 or 302 exists at a position remote from the person detecting device 130.

As for the correction of the position, for example, the position estimation unit 150 can perform the following processing.

In a case where the position estimation system 100 includes one person detecting device 130, on the basis of the assumption that the walking speeds of the persons 301, 302 are constant, the position estimation unit 150 calculates the distance from the person detecting device 130 by multiplying the walking speed by the elapsed time from the time point indicated by the latest position/time information to the current time indicated by the time information. In such a case, the position estimation unit 150 estimates that the position on the circular arc, which is concentrically separated by the calculated distance from the position of the person detecting device 130, is the position of the person 301 or 302.

In a case where the position estimation system 100 includes a plurality of person detecting devices 130, the position estimation unit 150 can more accurately estimate the positions of the persons 301, 302.

In this case, the position estimation unit 150 reads the latest position/time information and the second latest position/time information from the position/time information storage unit 145. In a case where the positions indicated by these pieces of information are different, the position estimation unit 150 can estimate the position by assuming that the movement of a person is a constant velocity linear motion calculated between the two positions as follows.

The position estimation unit 150 calculates an inter-device distance D which is a distance between positions indicated by these pieces of the information.

Next, the position estimation unit 150 calculates the required time T required for a person to move the inter-device distance D from the time points indicated by these pieces of the information.

Then, the position estimation unit 150 can calculate the walking speeds S of the persons 301, 302 by dividing the inter-device distance D by the required time T.

Thus, the position estimation unit 150 can estimate a position between the position indicated by the second latest position/time information and the position indicated by the latest position/time information in accordance with the generated time of the signal pattern information generated during the period from the time point indicated by the second latest position/time information to the time point indicated by the latest position/time information.

In such a case, the position estimation unit 150 suspends estimations of the positions from the time when the person detection information is detected until the next person detection information is detected, and may estimate a position between the positions indicated by the two pieces of the position/time information in a case where the position of the person detecting device 130 that transmitted the person detection information is different when the latest person detection information is input.

It should be noted that, in a case where the positions of the person detecting devices 130 that transmitted the person detection information are the same, the position estimation unit 150 may estimate the concentric positions about the positions of the person detecting devices 130 as in the case where one person detecting device 130 is provided.

Furthermore, when the position indicated by the person detecting device attribute information included in the existing signal pattern related information does not match the position indicated by the latest position/time information, the position estimation unit 150 deletes the existing signal pattern information stored in step S11 without estimating the position with respect to the signal pattern information generated by the analysis unit 142.

Next, in a case where the estimation of the position has been made, the position estimation unit 150 generates related information of the existing signal pattern information stored in the database 144 in step S11, and stores the generated related information in the database 144 in association with the existing signal pattern information (S17). As for the association, a unique number assigned to the signal pattern information may be used.

Then, the position estimation unit 150 determines whether or not to end the process in accordance with, for example, an instruction from an operator (S18). If the process is not ended (No in S18), the process returns to step S10.

Thus, by utilizing the reception intensity information and the person detection information in combination, the controlling device 140 can perform position estimation with high estimation accuracy on the basis of the position of the person detecting device 130.

In addition, even in a case where the person detecting device 130 is not a device capable of detecting the presence of a person with a high probability, such as a person proximity sensor described above, but is a device in which the person detection information is not always transmitted, such as when using device operation information of a household electrical appliance installed at a specific position, the signal patterns of the wireless signal will have a similarity regardless of the presence or absence of the device operation, so that the position can be estimated as long as the device operation or the like has been performed in the past.

Further, in the flowchart explained above, because the position of the person 301 or 302 can be estimated once the person detection information is input by the person detecting device 130, the estimated position information can be recorded together with the signal pattern specified by the received signal intensity information, and the stored information can be used as an existing signal pattern in the next position estimation processing. Therefore, it is not necessary to prepare the database 144 in advance as in the prior art.

In the flowchart shown in FIG. 4, in step S12, it is determined whether or not the person detecting device 130 has detected the proximity of a person, and if the proximity of a person has been detected, the processing in steps S13 to S15 are skipped, but the present embodiment is not limited to such an example. The detection by the person detecting device 130 and the processes from steps S13 to S15 may be performed in parallel, and if a predetermined time has elapsed since the process of step S10 started, the process may proceed to step S16. In such a case, when the detection by the person detecting device 130 is performed, giving priority to the position of the person detecting device 130 can improve the estimation accuracy of the position of the person 301 or 302.

In the flowchart shown in FIG. 4, the most similar signal pattern is extracted in step S13, but the present embodiment is not limited to such an example.

For example, in a case where the database 144 stores a plurality of similar signal patterns, whose distances between the signal patterns are the same or within a predetermined range, the existing signal pattern extraction unit 146 obtains related information corresponding to the plurality of similar signal patterns in step S13, and supplies them to the position estimation unit 150. The position estimation unit 150 may specify one piece of related information indicating the same position as the position of the person detecting device 130 that transmitted the latest person detection information stored in the position/time information storage unit 145, and use the specified related information. This is based on the assumption that, although there is a case where the position of the person 301 or 302 in the room 300 is completely different even if the signal pattern is similar, a past signal pattern more similar to the current signal pattern will be extracted if the position is the same as that of the person detecting device 130 which transmitted the person detection information just before.

Furthermore, when there are a plurality of signal patterns having the same positions, the position estimation unit 150 may select one piece of the related information having the shortest elapsed time. This is based on an assumption that, since the short elapsed time means that the elapsed time since the time point at which the person detecting device 130 identifies the person at the specific position is short, the reliability of the estimated position is higher.

Next, a description will be given of how the position estimation system 100 configured as described above can effectively estimate, when there are two persons in a room which is the space for detection, the position of any one of the persons.

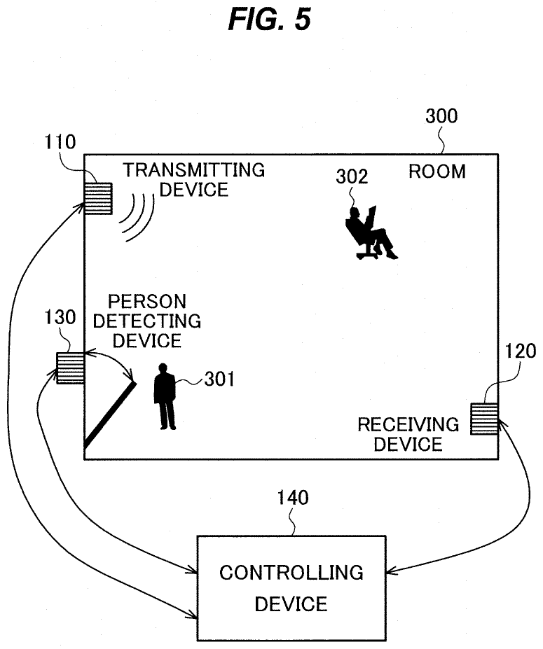

FIG. 5 is a schematic diagram illustrating a first example in which the person 301 and the person 302 exist in the room 300.

In the first example shown in FIG. 5, it is assumed that the person 301 is in a position close to the person detecting device 130 and the person detection information is output from the person detecting device 130.

The wireless signal transmitted from the transmitting device 110 is received by the receiving device 120 as a specific signal pattern P by reflection from the person 301, the person 302, and other objects affecting electromagnetic waves.

According to the flowchart shown in FIG. 4, since the person 301 exists at a position close to the person detecting device 130, the position information of the person detecting device 130 and the signal pattern P received at this time are recorded in the database 144 together.

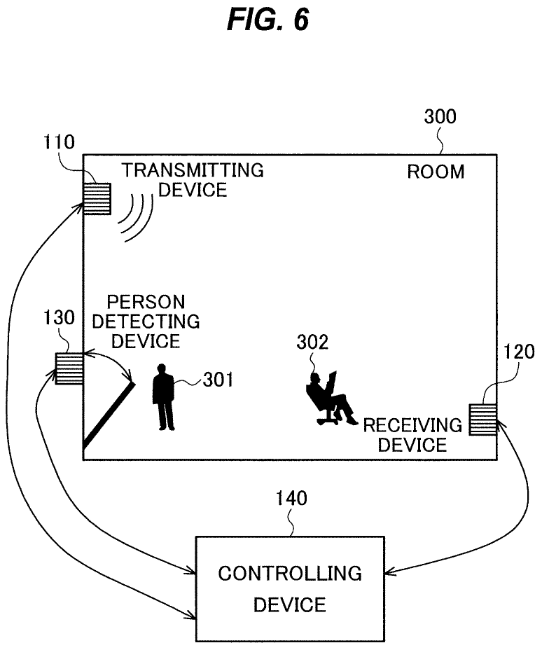

FIG. 6 is a schematic diagram illustrating a second example in which the person 301 and the person 302 exist in the room 300.

In the second example, the position of the person 302 is different from that in the first example.

Since the wireless signal reflected by the person 302 is different from the first example, in the second example, the receiving device 120 receives the wireless signal with a signal pattern Q different from the signal pattern P in the first example.

On the basis of only the signal pattern P and the signal pattern Q, it is difficult to recognize that these are the signal patterns when the person 301 is at the same position.

For this reason, when performing position estimation only by the signal pattern of the wireless communication as in the prior art, it was necessary to perform a preparation work by arranging the person 301 and the person 302 at corresponding positions in advance, obtaining the signal pattern P and the signal pattern Q, and recording the signal pattern information indicating each signal pattern in association with the position information of the person detecting device 130. Since the positions where the person 302 exists in the room 300 are innumerable, it is difficult to perform such preparation work and store necessary information because the amount of data to be stored is enormous.

In contrast, in the present embodiment, when obtaining the signal pattern P in the first example, the controlling device 140 records the signal pattern information indicating the signal pattern P in the database 144 together with the position information of the person detecting device 130. Further, when the controlling device obtains the signal pattern Q in the second example, the controlling device 140 stores the signal pattern information indicating the signal pattern Q in the database 144 together with the position information of the person detecting device 130. Therefore, the existing signal pattern recorded according to the position of the person 302 is recorded as necessary, and when the person 302 exists at the position recorded once, the position of the person 301 can be accurately estimated.

Although it is difficult to predict the position of the person 301 or the person 302 in each room 300, the combination has a high probability of existence due to, for example, allocation of the room 300 or arrangement of furniture. In the present embodiment, by preferentially recording the positions where the person 301 or the person 302 actually exists, it is possible to reduce the possibility that the amount of data enormously increases and to perform the position estimation with higher accuracy.

Although FIG. 5 and FIG. 6 have been described with reference to the case of two persons, similar effects can be expected for objects affecting the arrival of electromagnetic waves.

For example, even when an event affecting the electromagnetic wave environment in the room 300 such as opening and closing of a metal door, installation or removal of a large household electrical appliance, or construction of an adjacent building occurs after the installation of the position estimation system 100, the signal patterns after the occurrence of the effect and the position information derived from the person detecting device 130 are recorded in the database 144, so that the position of a person can be estimated with high accuracy.

In the present embodiment, the position estimation processing for the room 300 has been described, positions of persons can be estimated for the entire building with a plurality of rooms or for one floor of the building as long as the wireless signal from the transmitting device 110 to the receiving device 120 is reachable.

Since the position estimation system 100 of the present embodiment uses information indicating that a person exists at a specific position in addition to information from the receiving device 120 when estimating a position, it is not necessary to record the signal pattern information in advance, so that the amount of the signal pattern information to be recorded is reduced and the signal pattern can be collated in a short time.

In addition, even if there is another person who affects the signal pattern in the estimation target environment and the position of the other person changes variously, the signal pattern can be stored as data belonging to the person to be detected, and the database 144 can be expanded by learning. Therefore, the position of the estimation target person can be estimated with respect to the position of the person detecting device 130 as the reference position, and more accurate position estimation can be performed in advance.

The position estimation system 100 according to the present embodiment can record a signal pattern related to the position of a person in learning manner even when two or more persons exist in the room, and can register constantly existing positions in the database 144 at any time. Therefore, a similar past signal pattern can be extracted, and the position can be estimated.

Also, even when a plurality of signal patterns similar to the past signal patterns are included and the past signal patterns similar to the current signal patterns cannot be uniquely specified, the position similar to the nearest person detecting device 130 can be estimated, and the possibility of erroneously estimating the position away from the correct answer can be reduced.

### DESCRIPTION OF REFERENCE CHARACTERS

100 position estimation system, 110 transmitting device, 120 receiving device, 130 person detecting device, 140 controlling device, 141 reception intensity information input unit, 142 analysis unit, 143 storage unit, 146 existing signal pattern extraction unit, 147 person detection information input unit, 148 clocking unit, 149 transmitting device communication unit, 150 position estimation unit

1. A position estimation system, comprising:
an information processing device;
a transmitting device to transmit a wireless signal;
a receiving device to detect a reception intensity of the wireless signal and to sequentially output reception intensity information indicating the detected reception intensity to the information processing device; and
a person detecting device to sequentially output predetermined person detection information to the information processing device when a person existing within a predetermined range is detected,
wherein the information processing device comprises:
a reception intensity information input unit to receive input of the reception intensity information;
a person detection information input unit to receive input of the person detection information; and
processing circuitry to generate signal pattern information indicating a signal pattern indicating a transition of the reception intensity in a predetermined period by using the reception intensity indicated by the reception intensity information input in the predetermined period, and
to estimate, when the person detection information input unit receives input of the person detection information within the predetermined period the position of the person detecting device in the signal pattern indicated by the generated signal pattern information to be the position where a person exists.

2. The position estimation system according to claim 1, further comprising:
a storage unit to associate existing signal pattern information, elapsed time information indicating the elapsed time since the person detection information was last input, and person detecting device attribute information indicating the position of the person detecting device that last input the person detection information and to store the existing signal pattern information, the elapsed time information, and the person detecting device attribute information, the existing signal pattern information being the generated signal pattern information.

3. The position estimation system according to claim 1, further comprising:
a storage unit to associate existing signal pattern information, elapsed time information indicating the elapsed time since the person detection information was last input when the existing signal pattern information was generated, and person detecting device attribute information indicating the position of the person detecting device that last input the person detection information when the existing signal pattern information was generated with each other and to store the existing signal pattern information, the elapsed time information, and the person detecting device attribute information, the existing signal pattern information being signal pattern information in the past; wherein
the processing circuitry to read out the elapsed time information and the person detecting device attribute information associated with the existing signal pattern information indicating a signal pattern most similar to the signal pattern indicated by the generated signal pattern information from the storage unit, and
in a case where the person detection information input unit receives no input of the person detection information within the predetermined period, when the position indicated by the read person detecting device attribute information is the same as the position of the person detecting device that last input the person detection information and the elapsed time indicated by the read elapsed time information is shorter than the predetermined time, the processing circuitry estimates, to be the position where a person exists, the position of the person detecting device that last input the person detection information.

4. The position estimation system according to claim 1, further comprising:
a storage unit to associate existing signal pattern information, elapsed time information indicating the elapsed time since the person detection information was last input when the existing signal pattern information was generated, and person detecting device attribute information indicating the position of the person detecting device that last input the person detection information when the existing signal pattern information was generated and to store the existing signal pattern information, the elapsed time information, and the person detecting device attribute information, the existing signal pattern information being signal pattern information in the past; wherein
the processing circuitry to read out the elapsed time information and the person detecting device attribute information associated with the existing signal pattern information indicating a signal pattern most similar to the signal pattern indicated by the generated signal pattern information from the storage unit, and
in a case where the person detection information input unit receives no input of the person detection information within the predetermined period, when the position indicated by the read person detecting device attribute information is the same as the position of the person detecting device that last input the person detection information and the elapsed time indicated by the read elapsed time information is equal to or longer than the predetermined time, the processing circuitry estimates, to be the position where a person exists, a corrected position calculated by correcting the position of the person detecting device that last input the person detection information by a distance through which a person moves in the elapsed time since the person detection information was last input.

5. The position estimation system according to claim 3,
wherein the processing circuitry to make the storage unit associate existing signal pattern information, elapsed time information indicating the elapsed time since the person detection information was last input, and person detecting device attribute information indicating the position of the person detecting device that last input the person detection information and store the existing signal pattern information, the elapsed time information, and the person detecting device attribute information, the existing signal pattern information being the generated signal pattern information.

6. The position estimation system according to claim 3,
wherein, in a case where the storage unit stores a plurality of pieces of the existing signal pattern information indicating signal patterns most similar to the signal pattern indicated by the generated signal pattern information, the processing circuitry reads out, from the plurality of pieces of the existing signal pattern information in the storage unit, the elapsed time information and the person detecting device attribute information associated with one piece of the existing signal pattern information in which the position indicated by the associated person detecting device attribute information is the same as the position of the person detecting device that last input the person detection information.

7. The position estimation system according to claim 3,
wherein, in a case where the storage unit stores a plurality of pieces of the existing signal pattern information indicating signal patterns most similar to the signal pattern indicated by the generated signal pattern information, the processing circuitry reads out, from the plurality of pieces of the existing signal pattern information in the storage unit, the elapsed time information and the person detecting device attribute information associated with one piece of the existing signal pattern information in which the position indicated by the associated person detecting device attribute information is the same as the position of the person detecting device that last input the person detection information, and in which the elapsed time indicated by the associated elapsed time information is the shortest.

8. An information processing device; comprising
a reception intensity information input unit to receive, from a receiving device to detect a reception intensity of a wireless signal transmitted from a transmitting device and to sequentially output reception intensity information indicating the detected reception intensity, input of the reception intensity information;
a person detection information input unit to receive input of the person detection information from a person detecting device, the person detecting device detecting that a person exists within a predetermined range and sequentially outputting predetermined person detection information to the information processing device;
processing circuitry to generate signal pattern information indicating a signal pattern indicating a transition of the reception intensity in a predetermined period by using the reception intensity indicated by the reception intensity information input in the predetermined period, and
to estimate, when the person detection information input unit receives input of the person detection information within the predetermined period, to be the position where a person exists, the position of the person detecting device in the signal pattern indicated by the generated signal pattern information.

9. A non-transitory computer-readable storage medium storing program that causes a computer to function as:
a reception intensity information input unit to receive, from a receiving device to detect a reception intensity of a wireless signal transmitted from a transmitting device and to sequentially output reception intensity information indicating the detected reception intensity, input of the reception intensity information;
a person detection information input unit to receive input of the person detection information from a person detecting device, the person detecting device detecting that a person exists within a predetermined range and sequentially outputting predetermined person detection information to the information processing device; and
processing circuitry to generate signal pattern information indicating a signal pattern indicating a transition of the reception intensity in a predetermined period by using the reception intensity indicated by the reception intensity information input in the predetermined period, and
to estimate, when the person detection information input unit receives input of the person detection information within the predetermined period, to be the position where a person exists, the position of the person detecting device in the signal pattern indicated by the generated signal pattern information.

10. An information processing method, comprising
receiving, from a receiving device to detect a reception intensity of a wireless signal transmitted from a transmitting device and to sequentially output reception intensity information indicating the detected reception intensity, input of the reception intensity information;
generating signal pattern information indicating a signal pattern indicating a transition of the reception intensity in a predetermined period by using the reception intensity indicated by the reception intensity information input in the predetermined period;
receiving input of the person detection information from a person detecting device, the person detecting device detecting that a person exists within a predetermined range and sequentially outputting predetermined person detection information to the information processing device; and
estimating, when the person detection information input unit receives input of the person detection information within the predetermined period, to be the position where a person exists, the position of the person detecting device in the signal pattern indicated by the generated signal pattern information.

11. The position estimation system according to claim 4,
wherein the processing circuitry to make the storage unit associate existing signal pattern information, elapsed time information indicating the elapsed time since the person detection information was last input, and person detecting device attribute information indicating the position of the person detecting device that last input the person detection information and store the existing signal pattern information, the elapsed time information, and the person detecting device attribute information, the existing signal pattern information being the generated signal pattern information.

12. The position estimation system according to claim 4,
wherein, in a case where the storage unit stores a plurality of pieces of the existing signal pattern information indicating signal patterns most similar to the signal pattern indicated by the generated signal pattern information, the processing circuitry reads out, from the plurality of pieces of the existing signal pattern information in the storage unit, the elapsed time information and the person detecting device attribute information associated with one piece of the existing signal pattern information in which the position indicated by the associated person detecting device attribute information is the same as the position of the person detecting device that last input the person detection information.

13. The position estimation system according to claim 5,
wherein, in a case where the storage unit stores a plurality of pieces of the existing signal pattern information indicating signal patterns most similar to the signal pattern indicated by the generated signal pattern information, the processing circuitry reads out, from the plurality of pieces of the existing signal pattern information in the storage unit, the elapsed time information and the person detecting device attribute information associated with one piece of the existing signal pattern information in which the position indicated by the associated person detecting device attribute information is the same as the position of the person detecting device that last input the person detection information.

14. The position estimation system according to claim 11,
wherein, in a case where the storage unit stores a plurality of pieces of the existing signal pattern information indicating signal patterns most similar to the signal pattern indicated by the generated signal pattern information, the processing circuitry reads out, from the plurality of pieces of the existing signal pattern information in the storage unit, the elapsed time information and the person detecting device attribute information associated with one piece of the existing signal pattern information in which the position indicated by the associated person detecting device attribute information is the same as the position of the person detecting device that last input the person detection information.

15. The position estimation system according to claim 4,
wherein, in a case where the storage unit stores a plurality of pieces of the existing signal pattern information indicating signal patterns most similar to the signal pattern indicated by the generated signal pattern information, the processing circuitry reads out, from the plurality of pieces of the existing signal pattern information in the storage unit, the elapsed time information and the person detecting device attribute information associated with one piece of the existing signal pattern information in which the position indicated by the associated person detecting device attribute information is the same as the position of the person detecting device that last input the person detection information, and in which the elapsed time indicated by the associated elapsed time information is the shortest.

16. The position estimation system according to claim 5,
wherein, in a case where the storage unit stores a plurality of pieces of the existing signal pattern information indicating signal patterns most similar to the signal pattern indicated by the generated signal pattern information, the processing circuitry reads out, from the plurality of pieces of the existing signal pattern information in the storage unit, the elapsed time information and the person detecting device attribute information associated with one piece of the existing signal pattern information in which the position indicated by the associated person detecting device attribute information is the same as the position of the person detecting device that last input the person detection information, and in which the elapsed time indicated by the associated elapsed time information is the shortest.

17. The position estimation system according to claim 11,
wherein, in a case where the storage unit stores a plurality of pieces of the existing signal pattern information indicating signal patterns most similar to the signal pattern indicated by the generated signal pattern information, the processing circuitry reads out, from the plurality of pieces of the existing signal pattern information in the storage unit, the elapsed time information and the person detecting device attribute information associated with one piece of the existing signal pattern information in which the position indicated by the associated person detecting device attribute information is the same as the position of the person detecting device that last input the person detection information, and in which the elapsed time indicated by the associated elapsed time information is the shortest.
